(19) United States
(12) Patent Application Publication
(10) Pub. No.: US 2009/0243942 A1
(43) Pub. Date: Oct. 1, 2009

(54) MULTIBAND ANTENNA

(76) Inventor: Marko Tapio Autti, Oulu (FI)

Correspondence Address: DITTHAVONG MORI & STEINER, P.C., 918 Prince St., Alexandria, VA, 22314, US

(21) Appl. No.: 12/059,334

(22) Filed: Mar. 31, 2008

(51) Int. Cl. H01Q 1/42; H01P 11/00; H01Q 1/24; H01Q 1/36

(52) U.S. Cl. 343/702; 343/872; 343/895; 29/600

(57) ABSTRACT

The present invention relates to a compact multiband antenna arrangement and method of manufacturing such an arrangement, wherein a first support body is provided, which is at least partially hollow and which has an outer surface and an inner surface. A first antenna element is carried on the outer surface, and a second antenna element is carried on the inner surface or on an outer surface of a second support body which is at least partially inserted inside the first support body.

### FIELD OF THE INVENTION

The present invention relates to a multiband antenna and a method of manufacturing such a multiband antenna.

### BACKGROUND OF THE INVENTION

Increasing numbers of radio protocols and corresponding radio bands required in portable electronic devices, such as mobile terminal devices or handsets, have fostered the need for new ways of creating all of the required frequency bands in an ever decreasing space or volume within the device.

Instead of having a single antenna for a single frequency band, it would be valuable to have more than one radio protocol or frequency band covered by the same antenna.

EP 0 593 185 A1 discloses a compact wideband antenna arrangement where two compact antenna coils are arranged concentrically, one within the other. The first antenna coil is tuned to include a first frequency, and the second coil is tuned to include a second frequency different from the first frequency. One of the antenna coils is used for reception and is tuned to the reception frequency, while the other is used for transmission and is tuned to the transmission frequency.

Additionally, WO 99/14819 discloses a dual-band helix antenna with a parasitic element positioned either inside or outside of the helix antenna and parallel to the major axis of the helix. The parasitic element is positioned so that when radio frequency energy in the higher of two frequency bands is incident on the antenna arrangement, the helix antenna and the parasitic element are capacitively coupled, while when radio frequency energy in the lower of the two frequency bands is incident, the helix antenna is substantially isolated from the parasitic element. Thereby, the antenna arrangement is capable of operating in two or more widely separated frequency bands.

### SUMMARY OF THE INVENTION

In some embodiments an antenna arrangement comprises:
a first support body being at least partially hollow and having an outer surface and an inner surface;

a first antenna element carried on said outer surface; and

a second antenna element carried on said inner surface or on an outer surface of a second support body which is at least partially inserted inside said first support body.

Furthermore, in some embodiments a portable electronic device has an antenna arrangement which comprises:
a first support body being at least partially hollow and having an outer surface and an inner surface;
a first antenna element carried on said outer surface; and
a second antenna element carried on said inner surface or on an outer surface of a second support body which is at least partially inserted inside said first support body,
said antenna arrangement being mounted on a circuit board of said portable electronic device.

Further, in some embodiments an antenna arrangement comprises:
first support means for providing an outer surface and an inner surface, said support means being at least partially hollow;
first antenna means for providing a first resonance frequency, said first antenna means being carried on said outer surface; and
second antenna means for providing a second resonance frequency, said second antenna means being carried on said inner surface or on an outer surface of a second support means which is at least partially inserted inside said first support means.

Additionally, in some embodiments a method of manufacturing an antenna arrangement comprises:
providing a first support body with an at least partially hollow shape having an outer surface and an inner surface;
mounting a first antenna element on said outer surface; and
mounting a second antenna element on said inner surface.

Moreover, in some embodiments a method of manufacturing an antenna arrangement comprises:
providing a first support body with an at least partially hollow shape having an outer surface and an inner surface;
mounting a first antenna element on said outer surface;
mounting a second antenna element to an outer surface of a second support body; and
inserting said second support body at least partially into said first support body.

Accordingly, a multiband antenna construction is enabled by providing a multi-part mechanical structure which allows a first antenna to be carried on the outside surface of a first body, and a second antenna to be carried on the inside surface of the first body, or on the outside surface of a second body which is inserted inside the first body. The first body is completely or partially “hollowed” such that a second body can be inserted therein. The proposed mechanical construction of antenna arrangement makes possible multiband operation by using a floating parasitic antenna or resonator inside a main antenna or resonator. This enables tight packing of multi-resonant antennas into a small space, so that the size of multiband antennas can be reduced. The volume available inside the first support body can be used efficiently, while no galvanic or electric connection is needed for the second antenna.

The proposed manufacturing methods enable use of technologies such as three dimensional (3D) plating of conducting material (e.g. by laser direct structuring (LDS)) for antenna manufacturing.

In another embodiment, the second antenna element may be carried on the inner surface of the first support body and a third antenna element may be carried on the outer surface of the second support body. The third antenna element may for example be electrically connected to at least one of the first and second antenna elements.

Optionally, the second antenna element may not be galvanically connected to the first antenna element, so as to act as a floating parasitic resonator.

At least one of the first and second support bodies may be made of a dielectric material. Then, a dielectric constant of the first support body may differ from a dielectric constant of the second support body. More specifically, the second support body may be made of a material composition which enables a predetermined dielectric load on the first and second antenna elements at their respective operating frequencies.

In a specific exemplary implementation, the first and second antenna elements may be arranged in a helical structure. Thereby, a small helix antenna can be provided, in which multiband operation is made possible by using a coaxial and optionally floating parasitic helical resonator inside the main helical section or antenna.

In yet another specific exemplary implementation, the first antenna element may be a parasitic element and the second antenna element may be the fed or driven element, thereby forming the second antenna element within the parasitic element.

The second antenna element may have a resonance on at least one frequency which differs from a resonance frequency of the first antenna element.

Furthermore, the first and second support bodies may be configured in a substantially rectangular shape. The mounting or attaching of the first and second antenna elements or radiators may comprise metal plating a helical or other structure on the respective surface.

Further advantageous modifications are defined in the dependent claims.

### BRIEF DESCRIPTION OF THE DRAWINGS

In the following, the present invention will be described on the basis of embodiments with reference to the accompanying drawings in which:

FIG. 1 shows a schematic perspective side view of a main support body with separated sister body of a multiband antenna arrangement according to a first embodiment;

FIG. 2 shows a schematic block diagram of a mounted multiband antenna arrangement the according to the first embodiment;

FIG. 3 shows a schematic perspective side view of a concentric first and second helical antenna elements according to a fourth embodiment;

FIG. 4 shows a schematic perspective top view of the concentric first and second helical antenna elements according to the fourth embodiment;

FIG. 5 shows a schematic perspective lower side view of the concentric first and second helical antenna elements according to the fourth embodiment;

FIG. 6 shows a schematic flow diagram of a manufacturing procedure according to a first option;

FIG. 7 shows a schematic flow diagram of a manufacturing procedure according to a second option;

FIG. 8 shows a frequency diagram of a multiband antenna arrangement; and

FIG. 9 shows a schematic exploded view of a portable device according to a fifth embodiment.

### DESCRIPTION OF EMBODIMENTS

Embodiments will now be described on the basis of a multiband antenna arrangement with rectangular multi-part construction. It is apparent that the present invention is not intended to be limited to such a shape and that other shapes of the bodies and antenna elements are possible and feasible.

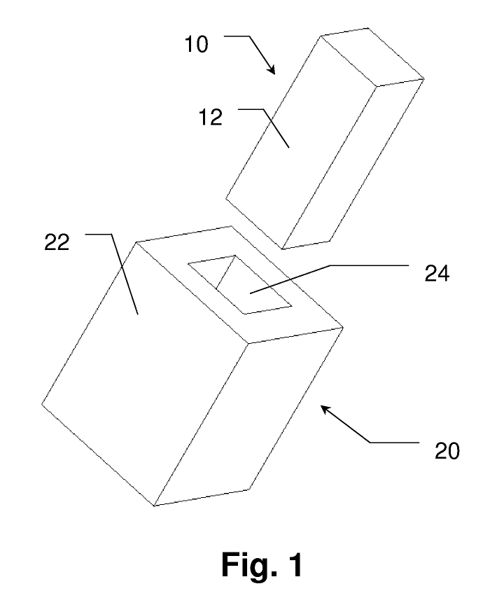

FIG. 1 shows a schematic perspective side view of a main support body with separated sister body of a multiband antenna arrangement according to a first embodiment.

The antenna arrangement, construction or assembly of FIG. 1 consist of two separate objects, namely a rectangular main body 20 which is completely or partially hollow and a rectangular sister body 10 which is completely or partially inside main body 20 when the antenna is assembled. The main body acts as a skeleton or support for a main antenna element or radiator (not shown in FIG. 1), e.g. helical structure, which has a resonance on at least one frequency and which is provided on at least a portion of an outer surface 22 and/or an inner surface 24 of the main body 20. The sister body 10 acts as a skeleton or support for a floating or non-floating parasitic antenna element radiator (not shown in FIG. 1), e.g. a helical structure, which is provided on at least a portion of an outer surface 12 of the sister body 10 and which has a resonance on at least one frequency, which differs from the frequency originated from the main radiator.

Thereby, a mechanical construction for a multiband antenna is provided in which multiband operation is made possible by using a floating or non-floating parasitic resonator inside the main antenna or resonator. Furthermore, the proposed mechanical construction enables antenna manufacturing by simply plating or depositing a metallic or conductive structure for the antenna elements or patterns on the respective surfaces in a three-dimensional manner. This arranging or mounting of the antenna patterns or elements on the inner and/or outer surfaces of the main and sister bodies may be achieved for example by LDS technology which is extremely flexible and requires only three process steps (molding, laser structuring, metallization) without any chemical surface activation (no acid), photoresist, or etching. Of course any other technologies for arranging metallic or other conductive antenna patterns on body surfaces can be used, for example, Molded Interconnect Device (MID) 3D molding technology.

This proposed mechanical antenna structure makes it possible to reduce the size of multiband antennas. It utilizes effectively the volume available inside the main body 20. In case of a floating parasitic resonator, no galvanic or electric connection is need for the inner second radiator.

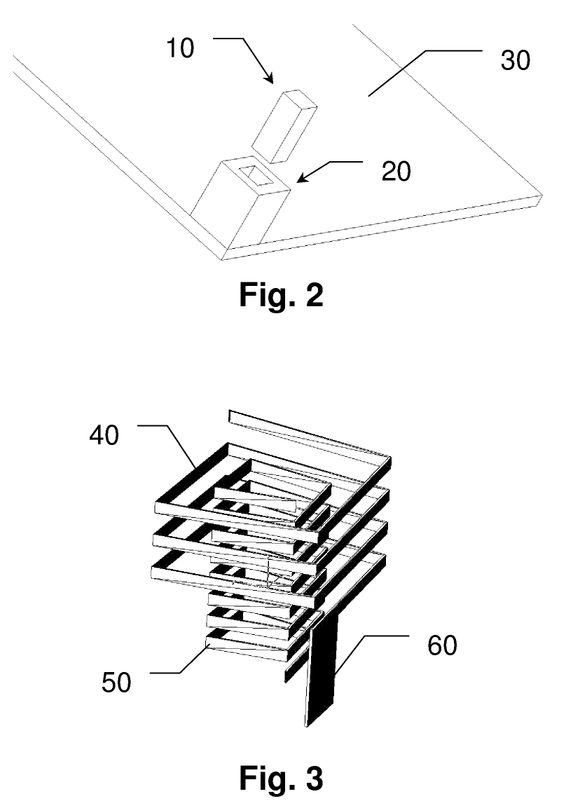

FIG. 2 shows a schematic block diagram of a mounted multiband antenna arrangement according to the first embodiment. Here, an implementation is shown, where the multi-band antenna arrangement of FIG. 1 (disassembled view with the sister body 10 shifted out of the main body 20) is mounted on a printed circuit board (PCB) or printed wiring board (PWB) 30. Thereby, a very compact arrangement of a transmitter, receiver, or transceiver circuit with multiband antenna can be achieved, e.g., for use in a portable electronic device such as a handset or the like. The PWB area required by the antenna arrangement can be substantially reduced by providing such a perpendicular arrangement.

As already mentioned, the proposed multiband antenna construction provides a multi-part mechanical component which allows the first antenna element to be carried on the outside surface 22 of the first or main body 20. The second antenna element may be carried on the outside surface 12 of the second or sister body 10 which is inserted inside the main body 20. The main body 20 is to be completely or partially “hollowed” such that a second body maybe inserted therein. This mechanical construction allows at least two antenna elements to be closely coupled utilizing at least two surfaces of a 3-dimensional component or components.

In a second embodiment the second antenna element may be carried on the inside surface 24 of the main body 20, while the sister body 10 may still be inserted into the main body 20. In other words, in the second embodiment the sister body 10 may have no conductive traces or patterns carried on its own surfaces.

The second antenna element may be a parasitic helical element or any other pattern. The sister body 10 may provide only a dielectric load to the main body 20 (which may have one or more antenna elements). The main body 20 may also provide some dielectric loading.

According to a third embodiment the main body 20 may carry a first antenna element on the outside surface 22 and a second antenna element on the inside surface 24, while the second antenna element may or may not be connected to the first antenna element. However, the first antenna element may be coupled to a third antenna element deposed on an outer surface of the sister body 10 inserted within the main body 20. In the third embodiment the third antenna element can be in circuit (e.g. galvanically or electrically coupled) with the second antenna element and may also be in circuit (e.g. galvanically or electrically coupled) with the first antenna element. The third antenna element is disposed on the sister body 10 which may have a substantially different dielectric constant compared to the main body 20.

FIG. 3 shows a schematic perspective side view of concentric first and second helical antenna elements 40, 50 according to a fourth embodiment.

Helical antenna elements can be configured to awake several resonances by changing the pitch of the helix or using another coaxial helix or whip connected to the same feed point.

The multiband helix antenna shown in FIG. 3 consist of a feeding (or vertical) section 60, a primary helical section (or helix) 40, and a secondary helical section (or helix) 50 coaxial to the primary helical section 40. In the present example of FIG. 3, the secondary helical section 50 section is not galvanically or electrically connected to the feeding section 60 and is therefore floating. The total length of both helical sections may be half of the wavelength at the respective resonance frequency.

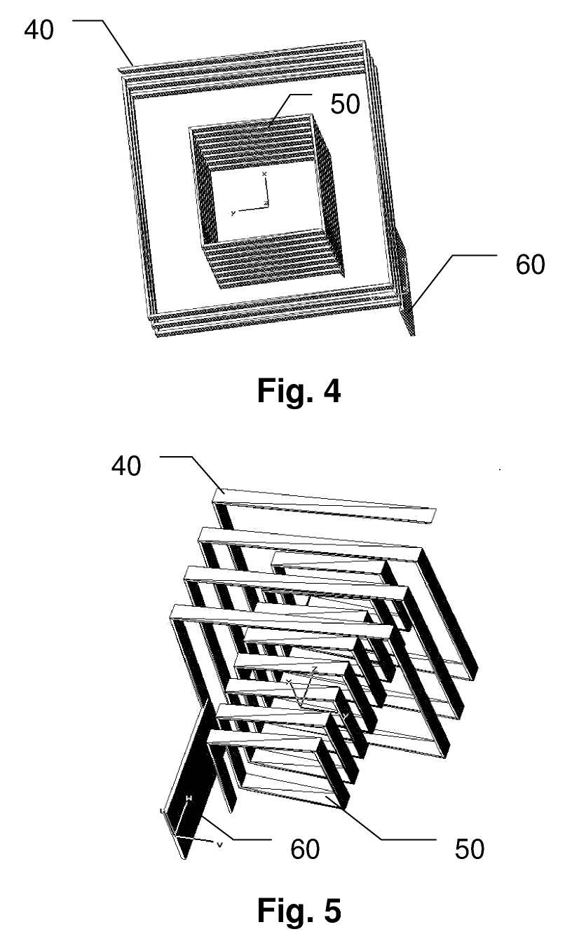

FIG. 4 shows a schematic perspective top view of the concentric primary and secondary helical antenna elements or sections 40, 50 according to the fourth embodiment. Here, the floating configuration of the secondary helical section 50 becomes fully apparent.

FIG. 5 shows a schematic perspective lower side view of the concentric first and second helical antenna elements according to the fourth embodiment. The primary helical antenna section 40 may be mounted or disposed as antenna pattern on the outer surface of the main body 20 of FIGS. 1 and 2, while the secondary helical section 50 may be mounted or disposed on the outer surface of the sister body 10 or on the inner surface of the main body 20.

Arranging or mounting or disposing of the antenna patterns or elements (e.g. helical antenna sections of FIGS. 3 to 5) on the inner and/or outer surfaces of the main and sister bodies 20, 10 may be achieved for example by LDS technology which is extremely flexible and requires only three process steps (molding, laser structuring, metallization) without any chemical surface activation (no acid), photoresist, or etching. Of course any other technologies for arranging metallic or other conductive antenna patterns on body surfaces can be used.

Based on the above embodiments, at least two manufacturing procedures or methods can be distinguished for the proposed antenna arrangement.

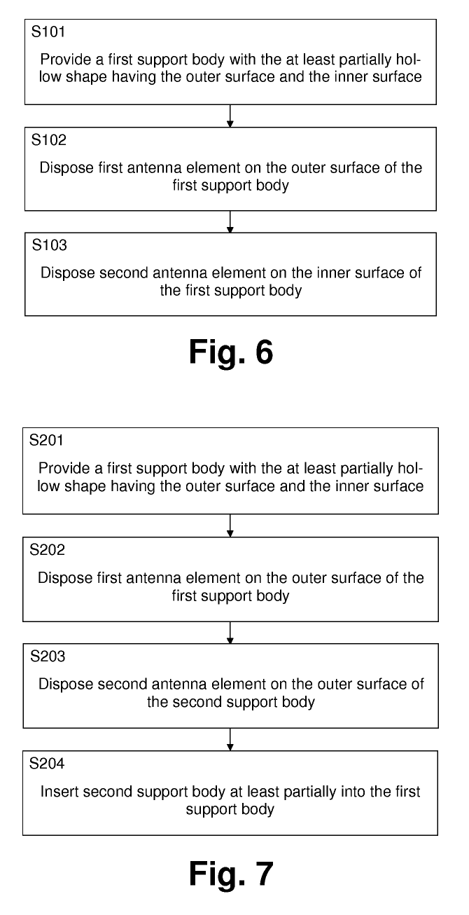

FIG. 6 shows a schematic flow diagram of a manufacturing procedure according to a first option. In step S101, a first support body (e.g. main body 20) with an at least partially hollow shape having an outer surface and an inner surface is provided as a first mechanical part. Then, in step S102, the first antenna element (e.g. primary helical section 40) is mounted or deposited on the outer surface of the first support body. Finally, in step S103, the second antenna element (e.g. secondary helical section 50) is mounted or deposited on the inner surface of the first support body. Optionally, a second support body (e.g. sister body 10) may be inserted as a second mechanical part into the first support body.

FIG. 7 shows a schematic flow diagram of a manufacturing procedure according to a second option. In step S201, the first support body (e.g. main body 20) with the at least partially hollow shape having the outer surface and the inner surface is provided as the first mechanical part. Then, in step S202, the first antenna element (e.g. primary helical section 40) is mounted or disposed on the outer surface of the first support body. Thereafter, in step S203, the second antenna element is mounted or disposed on the outer surface of the second support body (e.g. sister body 10). Finally, in step S204, the second support body is inserted at least partially into the first support body. The section option provides the advantage that both antenna elements can be mounted or disposed on an outer surface of a support body.

When the antenna arrangement of the above third embodiment is manufactured, a combination of the above first and second options may be used to mount or dispose the proposed three antenna elements.

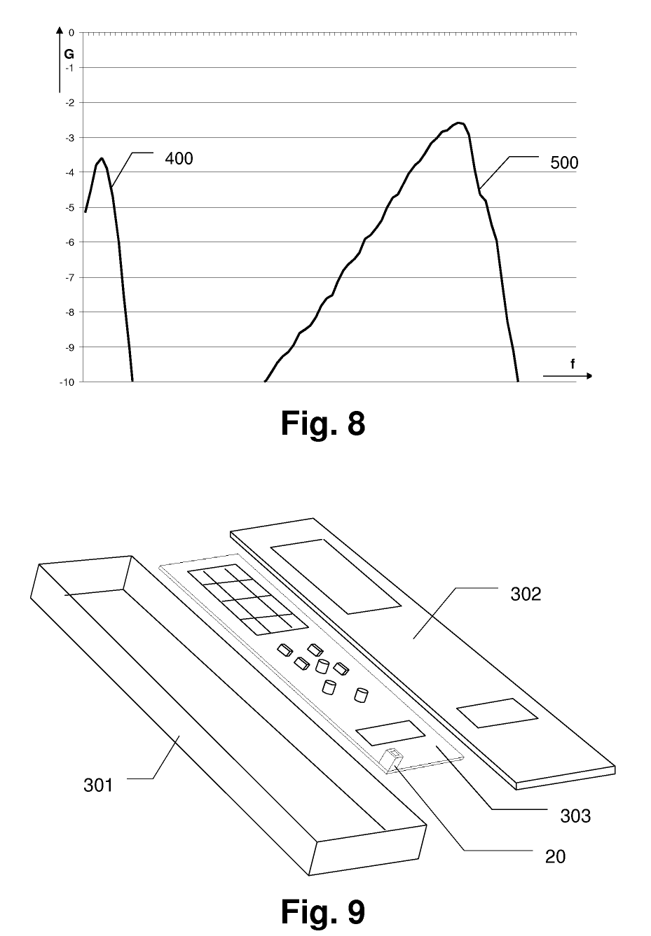

FIG. 8 shows a frequency diagram of a multiband antenna arrangement. Two different maxima 400, 500 which correspond to the resonance frequencies of the first and second antenna elements (e.g. primary and secondary helical sections 40, 50 of FIGS. 3 to 5) are shown. Hence, the material composition of the main and sister bodies 20, 10 and/or the structure of the first and second antenna elements can be adapted in a manner so that the size and location of these maxima 400, 500 are matched with frequency bands of desired radio protocols, to thereby provide an adapted multiband antenna arrangement.

FIG. 9 shows a schematic exploded view of a portable electronic device (e.g. a mobile phone) according to a fifth embodiment. The portable electronic device includes a back cover 301 and a front cover 302 which in their assembled state form a housing of the portable electronic device. Furthermore, a printed circuit board (PCB) or printed wiring board (PWB) 303 is inserted into the housing in the assembled state where the front cover 302 is fixed onto the back cover 301. The PCB or PWB 303 is shown with a schematic keypad and display and with the proposed multiband antenna arrangement 20.

As can be gathered from FIG. 9, the proposed multiband antenna arrangement 20 can be made very compact in size and requires little space on the PCB or PWB 303. It is noted that the multiband antenna arrangement 20 can be arranged at other locations on the PCB or PWB 303, as well, or even somewhere else within or at the outside of the housing.

In summary, a compact multiband antenna arrangement and method of manufacturing such an arrangement have been described, wherein a first support body is provided, which is at least partially hollow and which has an outer surface and an inner surface. A first antenna element is carried on the outer surface, and a second antenna element is carried on the inner surface or on an outer surface of a second support body which is at least partially inserted inside the first support body.

It is to be noted that the present invention is not restricted to the above preferred embodiment but can be implemented in connection with any at least partially hollow body of any shape having outer and inner surfaces. Any kind and pattern of antenna elements may be carried on at least some portions of the inner and outer surfaces of the two support bodies. It is even possible to insert more than one sister body with or without antenna element into the main body. The antenna elements or patterns or structures need not be arranged in a concentric manner. They can be arranged at different surface portions, with different patterns and/or pattern orientations. The preferred embodiment may thus vary within the scope of the attached claims.

1. An antenna arrangement comprising:
a first support body being at least partially hollow and having an outer surface and an inner surface;
a first antenna element carried on said outer surface; and
a second antenna element carried on said inner surface or on an outer surface of a second support body which is at least partially inserted inside said first support body.

2. The antenna arrangement according to claim 1, wherein said second antenna element is carried on said inner surface of said first support body and a third antenna element is carried on said outer surface of said second support body.

3. The antenna arrangement according to claim 1, wherein said second antenna element is not galvanically connected to said first antenna element and acts as a floating parasitic resonator.

4. The antenna arrangement according to claim 2, wherein said third antenna element is electrically connected to at least one of said first and second antenna elements.

5. The antenna arrangement according to claim 1, wherein at least one of said first and second support bodies is made of a dielectric material.

6. The antenna arrangement according to claim 5, wherein a dielectric constant of said first support body differs from a dielectric constant of said second support body.

7. The antenna arrangement according to claim 1, wherein said second support body is made of a material composition which enables a predetermined dielectric load on said first and second antenna elements at their respective operating frequencies

8. The antenna arrangement according to claim 1, wherein said first and second antenna elements are arranged in a helical structure.

9. The antenna arrangement according to claim 1, wherein said second antenna element has a resonance on at least one frequency which differs from a resonance frequency of said first antenna element.

10. The antenna arrangement according to claim 1, wherein said first and second support bodies are configured in a substantially rectangular shape.

11. A portable electronic device having an antenna arrangement which comprises:
a first support body being at least partially hollow and having an outer surface and an inner surface;
a first antenna element carried on said outer surface; and
a second antenna element carried on said inner surface or on an outer surface of a second support body which is at least partially inserted inside said first support body,
said antenna arrangement being mounted on a circuit board of said portable electronic device.

12. A method of manufacturing an antenna arrangement, said method comprising:
providing a first support body with an at least partially hollow shape having an outer surface and an inner surface;
mounting a first antenna element on said outer surface; and
mounting a second antenna element on said inner surface.

13. A method of manufacturing an antenna arrangement, said method comprising:
providing a first support body with an at least partially hollow shape having an outer surface and an inner surface;
mounting a first antenna element on said outer surface;
mounting a second antenna element to an outer surface of a second support body; and
inserting said second support body at least partially into said first support body.

14. The method according to claim 12, wherein said mounting comprises metal plating a helical structure on the respective surface.

15. An antenna arrangement comprising:
first support means for providing an outer surface and an inner surface, said support means being at least partially hollow;
first antenna means for providing a first resonance frequency, said first antenna means being carried on said outer surface; and
second antenna means for providing a second resonance frequency, said second antenna means being carried on said inner surface or on an outer surface of a second support means which is at least partially inserted inside said first support means.

16. The antenna arrangement according to claim 15, wherein said second antenna means is carried on said inner surface of said first support means and a third antenna means is carried on said outer surface of said second support means.

17. The antenna arrangement according to claim 15, wherein said second antenna means is not galvanically connected to said first antenna means and acts as a floating parasitic resonator.

18. The antenna arrangement according to claim 16, wherein said third antenna means is electrically connected to at least one of said first and second antenna means.
